(19) United States
(12) Patent Application Publication
(10) Pub. No.: US 2006/0294088 A1
(43) Pub. Date: Dec. 28, 2006

(54) Method, system, and computer program product for caching dynamically generated queries

(75) Inventors: John J. Stecher, Rochester, MN (US); Soloman J. Barghouthi, Rochester, MN (US); Matt R. Hogstrom, Cary, NC (US); Yang Lei, Cary, NC (US); Andrew W. Spyker, Raleigh, NC (US); Robert Wisniewski, Rochester, MN (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/167,504

(22) Filed: Jun. 27, 2005

(51) Int. Cl. G06F 17/30

(52) U.S. Cl. 707/4

(57) ABSTRACT

The present invention provides a method, system, and computer program product for caching dynamically generated queries such as SQL (Structured Query Language) statements. A method in accordance with an embodiment of the present invention comprises: providing a partial update query for updating at least one column in a table stored in a database; generating a key using a number representative of an update status of each column in the table; and determining if a prepared statement corresponding to the partial update query is located in a prepared statement cache using the key.

### BACKGROUND OF THE INVENTION

1. Field of the Invention

The present invention generally relates to caching. More particularly, the present invention provides a method, system, and computer program product for caching dynamically generated queries such as SQL (Structured Query Language) statements.

2. Related Art

Currently, most J2EE (Java 2 Platform Enterprise Edition) application servers, when persisting data to a database, either issue a full update SQL statement representing the data in a table to the database or a partial update SQL statement representing a subset of the data in the table. This process is described below with regard to TABLE 1.

TABLE 1
(CustomerTable):

| Customer_ID | First_Name | Last_Name | Phone_Number |
|---|---|---|---|
| 0000967 | Joe | Smith | 555-555-1455 |
| 0000968 | Sally | Shoes | 555-555-9191 |

TABLE 1 includes four columns of data: Customer_ID, First_Name, Last_Name, and Phone_Number. The following dynamically generated SQL statement is a full update SQL statement that updates every row in TABLE 1:
Full Update SQL Statement: UPDATE CustomerTable SET First_Name=?, Last_Name=?, Phone_Number=?, WHERE Customer_ID=?
   The following dynamically generated SQL statement is a partial update SQL statement that updates only the Last_Name column of TABLE 1:
Partial Update SQL Statement: UPDATE CustomerTable SET Last_Name=? WHERE Customer_ID=?
   Advantageously, by using partial update SQL statements such as the one shown above instead of always using a full update SQL statement, application server vendors have been able to increase the performance of their persistence model significantly by transmitting less data to the database which optimizes its ability to process the update.

To use partial update SQL statements and achieve an advantage over the full update SQL statement mechanism described above, an application server must cache the many prepared partial update SQL statements that may be generated for a given table in a prepared statement cache. With full update SQL statements, this caching is very simple because there is only one full update SQL statement per table, and when updating a table row only the single associated full update SQL statement is required. When dealing with many partial update SQL statements per table, however, a faster, more efficient way to identify the correct partial update SQL statement in the prepared statement cache is needed to avoid negating the performance benefits provided by partial update SQL statements.

When it comes to caching performance, the lookup of data in a cache is one of the most critical steps of the process. Currently, the state of the art for application servers is to cache each partial update SQL statement using the character string of the partial update SQL statement as the key into the cache. This is very inefficient as the character string must be generated each and every time a corresponding partial update SQL statement is to be retrieved and executed. This creates excess objects and garbage inside of the application server, lengthens the response time, and has been shown to consume up to ten percent (10%) of processor cycles in high throughput cases.

When an SQL statement for accessing data from a database is used for the first time, it is generated and placed into the prepared statement cache using a key/value pair, where the key is the character string of the SQL statement being executed and the value is the prepared SQL statement. Referring again to TABLE 1, assume that an application is updating a customer's first and last name. The current state of the art looks in the prepared statement cache for the following character string as the key to the corresponding prepared statement:
Partial Update Key: “UPDATE CustomerTable SET First_Name=? Last_Name=? WHERE Customer_ID=?”
   A second example is as follows. Assume the same application now wants to update only the last name of a customer. In this case, the prepared statement cached is examined for following character string as the key to the corresponding prepared statement:
Partial Update Key: “UPDATE CustomerTable SET Last_Name=? WHERE Customer_ID=?”
   Such character strings when used as keys into a cache are very cumbersome and poor performing due to the large CPU cost required to compare them letter by letter with each other.

### SUMMARY OF THE INVENTION

The present invention provides a method, system, and computer program product for caching dynamically generated queries such as SQL statements.

A first aspect of the present invention is directed to a method for caching a dynamically generated query, comprising: providing a partial update query for updating at least one column in a table stored in a database; generating a key using a number representative of an update status of each column in the table; and determining if a prepared statement corresponding to the partial update query is located in a prepared statement cache using the key.

A second aspect of the present invention is directed to a system for caching a dynamically generated query, comprising: a system for providing a partial update query for updating at least one column in a table stored in a database; a system for generating a key using a number representative of an update status of each column in the table; and a system for determining if a prepared statement corresponding to the partial update query is located in a prepared statement cache using the key.

A third aspect of the present invention is directed to a program product stored on a computer readable medium for caching a dynamically generated query, the computer readable medium comprising program code for performing the following steps: providing a partial update query for updating at least one column in a table stored in a database; generating a key using a number representative of an update status of each column in the table; and determining if a prepared statement corresponding to the partial update query is located in a prepared statement cache using the key.

A fourth aspect of the present invention provides a method for deploying an application for caching a dynamically generated query, comprising: providing a computer infrastructure being operable to: provide a partial update query for updating at least one column in a table stored in a database; generate a key using a number representative of an update status of each column in the table; and determine if a prepared statement corresponding to the partial update query is located in a prepared statement cache using the key.

A fifth aspect of the present invention provides computer software embodied in a propagated signal for deploying an application for caching a dynamically generated query, the computer software comprising instructions to cause a computer system to perform the following functions: providing a computer infrastructure being operable to: provide a partial update query for updating at least one column in a table stored in a database; generate a key using a number representative of an update status of each column in the table; and determine if a prepared statement corresponding to the partial update query is located in a prepared statement cache using the key.

A sixth aspect of the present invention provides a method for caching a dynamically generated query, comprising: providing a dynamically generated update query for updating at least one column in a table stored in a database; and generating a key for locating a prepared statement corresponding to the dynamically generated query in a prepared statement cache using a number representative of an update status of each column in the table.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a flow diagram of a method for caching dynamically generated queries in accordance with an embodiment of the present invention.

FIG. 2 depicts an illustrative application server for implementing an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

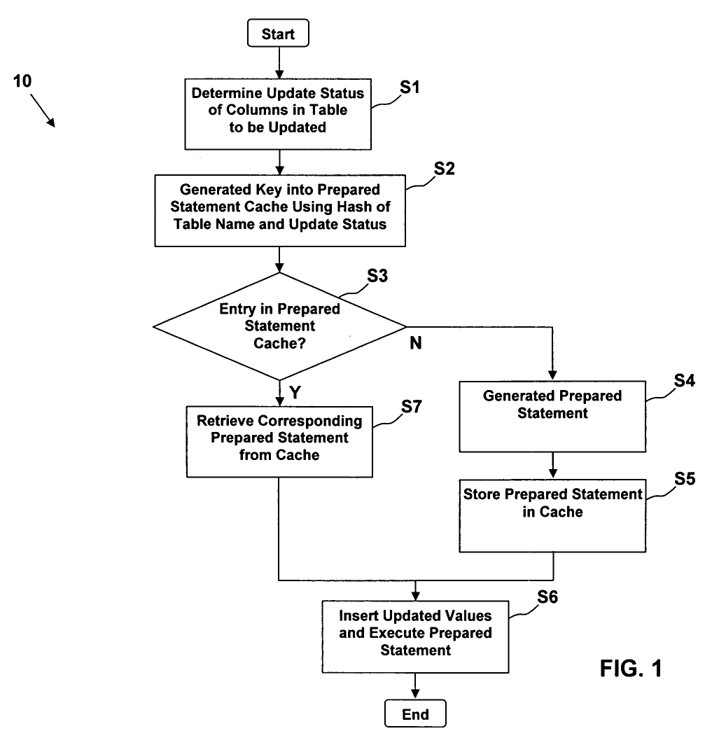

A flow diagram 10 of a method for caching dynamically generated queries in accordance with an embodiment of the present invention is depicted in FIG. 1. In step S1, during the processing of a partial update SQL statement, the columns (fields) in a table in a database to be updated are demarcated as follows:
Updated Column: “1”; and
Unchanged Column: “0.”
   Thus, using the above example (i.e., TABLE 1), for the partial update SQL statement “UPDATE CustomerTable SET First_Name=? Last_Name=? WHERE Customer_ID=?,” the update status of the columns in the table is represented as the number “0110.” Similarly, for the partial update SQL statement “UPDATE CustomerTable SET Last_Name=? WHERE Customer_ID=?,” the update status of the columns in the table is represented by the number “0010.” This process can be carried out in a plurality of different ways. For example, in a Websphere application server, available from International Business Machines, the Websphere persistence manager uses a “dirty” bit to indicate the update status of each column in a table. To this extent, the status of the dirty bit can be used to map a “0” to each column in a table that has not been updated and to map a “1” to each column in the table that has been updated.

In step S2, a key into a prepared statement cache is generated using a hash of the table name and the number representing the update status of the columns in the table. For example, for the partial update SQL statement “UPDATE CustomerTable SET First_Name=? Last_Name=? WHERE Customer_ID=?,” the key would be as follows:
Key=(hash of “CustomerTable”)0110
   Similarly, for the partial update SQL statement “UPDATE CustomerTable SET Last_Name=? WHERE Customer_ID=?,” the key would be as follows:
Key=(hash of “CustomerTable”)0010

In step S2, it is assumed that a global prepared statement cache is being used. If, however, a separate prepared statement cache is used for each table, then just the update status of the columns in the table can be used as the key into a respective prepared statement cache.

In step S3, the key generated in step S2 is used to look up a prepared statement corresponding to the partial update SQL statement in the prepared statement cache. If the key is not found in the prepared statement cache, indicating that the partial update SQL statement is being used for the first time, a prepared statement is generated in step S4 and is stored in the prepared statement cache in step S5 in a key/value pair. The key in the key/value pair comprises the key generated in step S2, while the value comprises the prepared statement generated in step S4. Flow then passes to step S6 where the updated values are inserted into the prepared statement and the prepared statement is executed. If the key is found in the prepared statement cache in step S3, then the corresponding prepared statement is retrieved from the prepared statement cache in step S7 and flow passes to step S6.

Use of the key generated in step S2 allows a prepared statement stored in a prepared statement cache to be looked up in real time and returned quickly for use, since number comparisons typically comprise a single CPU instruction. Contrastingly, when using a character string key as in the prior art, a string comparison may require thousands of CPU instructions.

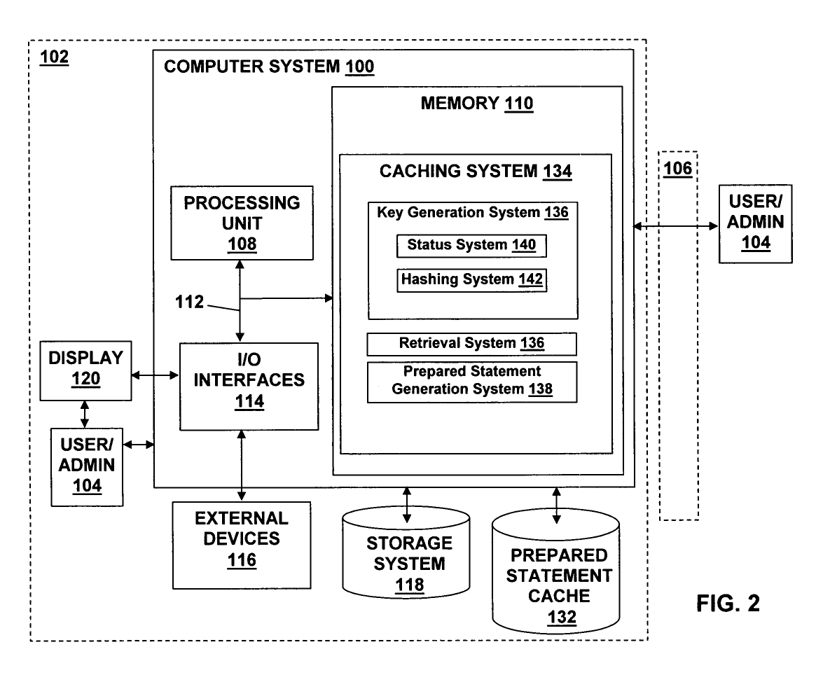

An application server 100 for implementing a method for caching dynamically generated queries in accordance with an embodiment of the present invention is depicted in FIG. 2. Application server 100 is provided in a computer infrastructure 102. A user/administrator 104 can access application server 100 directly, or can operate a computer system that communicates with application server 100 over a network 106 (e.g., the Internet, a wide area network (WAN), a local area network (LAN), a virtual private network (VPN), etc). In the case of the latter, communications between application server 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Application server 100 is shown including a processing unit 108, a memory 110, a bus 112, and input/output (I/O) interfaces 114. Further, application server 100 is shown in communication with external devices/resources 116 and one or more storage systems 118. In general, processing unit 108 executes computer program code, such as caching system 130, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with application server 100 and/or any devices (e.g., network card, modem, etc.) that enable application server 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, application server 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, etc.) not shown in FIG. 2 can be included in application server 100.

Storage system(s) 118 can be any type of system (e.g., a database) capable of providing storage for information under the present invention. Such information can include, for example, tables, table values, SQL statements, etc. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user/administrator 104 can contain computerized components similar to those described above with regard to application server 100.

Shown in memory 110 (e.g., as a computer program product) is a caching system 130 for caching dynamically generated queries in a prepared statement cache 132 in accordance with an embodiment of the present invention. The caching system 130 includes a key generation system 134 for generating a key into the prepared statement cache 132, a retrieval system 136 for retrieving a prepared statement from the prepared statement cache 132 using a key provided by the key generation system 134, and a prepared statement generation system 138 for generating a prepared statement based on a partial update SQL statement for storage into the prepared statement cache 132. The key generation system 134 includes a status system 140 for determining a number representing the update status of columns in a table to be updated and a hashing system 142 for providing a hash of the name of the table to be updated. The key generation system 140 combines the hash of a table name and the number representing the update status of the table to generate the key into the prepared statement cache 132.

The present invention can be offered as a business method on a subscription or fee basis. For example, one or more components of the present invention can be created, maintained, supported, and/or deployed by a service provider that offers the functions described herein for customers. That is, a service provider can be used to provide the caching of dynamically generated queries, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk—read only disk (CD-ROM), a compact disk—read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for caching a dynamically generated query, comprising:
providing a partial update query for updating at least one column in a table stored in a database;
generating a key using a number representative of an update status of each column in the table; and
determining if a prepared statement corresponding to the partial update query is located in a prepared statement cache using the key.

2. The method of claim 1, wherein the partial update query comprises a Structured Query Language (SQL) statement.

3. The method of claim 1, wherein the step of generating the key further comprises:
hashing a name of the table; and
generating the key by combining the hashed name of the table with the number representative of the update status of each column in the table.

4. The method of claim 1, further comprising:
generating a prepared statement corresponding to the partial update query, if the key is not found in the prepared statement cache.

5. The method of claim 4, further comprising:
storing the generated prepared statement corresponding to the partial update query in the prepared statement cache.

6. The method of claim 5, further comprising:
storing the key and the generated prepared statement in the prepared statement cache as a key/value pair.

7. The method of claim 4, further comprising:
inserting updated values into the generated prepared statement; and
executing the generated prepared statement.

8. The method of claim 1, further comprising:
retrieving the prepared statement corresponding to the partial update query from the prepared statement cache, if the key is found in the prepared statement cache.

9. The method of claim 6, further comprising:
inserting updated values into the retrieved prepared statement; and
executing the retrieved prepared statement.

10. Deploying an application for caching a dynamically generated query, comprising:
providing a computer infrastructure being operable to perform the method of claim 1.

11. Computer software embodied in a propagated signal for caching a dynamically generated query, the computer software comprising instructions to cause a computer system to perform the method of claim 1.

12. A system for caching a dynamically generated query, comprising:
a system for providing a partial update query for updating at least one column in a table stored in a database;
a system for generating a key using a number representative of an update status of each column in the table; and
a system for determining if a prepared statement corresponding to the partial update query is located in a prepared statement cache using the key.

13. The system of claim 12, wherein the partial update query comprises a Structured Query Language (SQL) statement.

14. The system of claim 12, wherein the system for generating the key further comprises:
a system for hashing a name of the table; and
a system for generating the key by combining the hashed name of the table with the number representative of the update status of each column in the table.

15. The system of claim 12, further comprising:
a system for generating a prepared statement corresponding to the partial update query, if the key is not found in the prepared statement cache.

16. The system of claim 15, further comprising:
a system for storing the generated prepared statement corresponding to the partial update query in the prepared statement cache.

17. The system of claim 16, further comprising:
a system for storing the key and the generated prepared statement in the prepared statement cache as a key/value pair.

18. The system of claim 15, further comprising:
a system for inserting updated values into the generated prepared statement; and
a system for executing the generated prepared statement.

19. The system of claim 12, further comprising:
a system for retrieving the prepared statement corresponding to the partial update query from the prepared statement cache, if the key is found in the prepared statement cache.

20. The system of claim 19, further comprising:
a system for inserting updated values into the retrieved prepared statement; and
a system for executing the retrieved prepared statement.

21. A program product stored on a computer readable medium for caching a dynamically generated query, the computer readable medium comprising program code for performing the steps of:
providing a partial update query for updating at least one column in a table stored in a database;
generating a key using a number representative of an update status of each column in the table; and
determining if a prepared statement corresponding to the partial update query is located in a prepared statement cache using the key.

22. A method for caching a dynamically generated query, comprising:
providing a dynamically generated update query for updating at least one column in a table stored in a database; and
generating a key for locating a prepared statement corresponding to the dynamically generated query in a prepared statement cache using a number representative of an update status of each column in the table.

23. The method of claim 22, wherein the step of generating the key further comprises:
hashing a name of the table; and
generating the key by combining the hashed name of the table with the number representative of the update status of each column in the table.
